(19) United States
(12) Patent Application Publication
(10) Pub. No.: US 2018/0298908 A1
(43) Pub. Date: Oct. 18, 2018

(54) ELECTRIC MOTOR FOR AN AIR BLOWING DEVICE AND AIR BLOWING DEVICE

(71) Applicant: Valeo Systemes Thermiques, Le Mesnil Saint Denis (FR)

(72) Inventors: Geoffroy Capoulun, Le Mesnil Saint-Denis (FR); Pascal Guigou, Le Mesnil Saint-Denis (FR)

(73) Assignee: Valeo Systemes Thermiques, Le Mesnil Saint Denis (FR)

(21) Appl. No.: 15/737,974

(22) PCT Filed: Jun. 10, 2016
(86) PCT No.: PCT/EP2016/063352

§ 371 Date: Dec. 19, 2017

(30) Foreign Application Priority Data
Jun. 29, 2015 (FR) 1556013

(51) Int. Cl. F04D 25/06; H02K 11/22; H02K 11/01; H02K 1/18

(52) U.S. Cl. CPC F04D 25/064; H02K 1/187; H02K 11/01; H02K 11/022

(57) ABSTRACT

Electric motor (1) for an air blowing device, comprising a rotor (2), a stator (4), a support (12) for said rotor (2) and said stator (4) able to dissipate heat and a screening cap (26), characterized in that the screening cap (26) is fixed to the support (12) of said rotor (2) and of said stator (4) by a fixing means (28). The invention also relates to an air blowing device comprising such an electric motor (1).

### TECHNICAL FIELD OF THE INVENTION

The present invention relates to the field of electric motors, particularly those used for the air blowing devices of a motor vehicle heating, ventilation and/or air conditioning system (also known by the acronym “HVAC”).

### PRIOR ART

A motor vehicle is commonly provided with a ventilation, heating and/or air conditioning device in order to regulate the temperature of an air flow delivered towards the inside of the passenger compartment of the vehicle. The device generally comprises a cover delimited by separations in which openings, including at least one air inlet and at least one air outlet, are organized.

In a known manner, the cover houses an air blowing device or blower, in order to circulate the air flow from the air inlet towards the air outlet. The cover also houses heat treatment means for heating and/or cooling the air flow prior to the delivery thereof inside the passenger compartment.

The blowers generally include electronically commutated electric motors, or brushless direct current motors. These motors include an assembly of a rotor and a stator, each of these components carrying electromagnetic elements, the interaction of which generates the movement of the rotor relative to the stator. The rotor and the stator are mounted independently of each other in said motor, and it should be checked that the relative positioning of these two components is correct for optimum operation of the motor.

Moreover, a problem that exists with this type of motor is that, during use, electromagnetic radiation is generated, but it can disrupt the operation of other electronic units placed in proximity to said motor.

### DISCLOSURE OF THE INVENTION

The aim of the present invention is to overcome at least some of the aforementioned disadvantages and to propose an electric motor and an associated air blowing device making it possible, in particular, to limit the propagation of electromagnetic radiation outside said motor.

For this purpose, the invention proposes an electric motor for an air blowing device, comprising a rotor, a stator, a support for said rotor and for said stator which is suitable for dissipating heat and a shielding cap characterized in that the shielding cap is linked to said support for said rotor and for said stator by a mean for fixing.

In this manner, it is possible to easily position a shielding cap which limits the propagation of the electromagnetic radiation generated by the coils of the stator. More particularly, the shielding cap is, thus, arranged in immediate proximity to the stator thus allowing for better confinement of the electromagnetic radiation.

Specific embodiments according to the invention propose that:
the mean for fixing comprises a first part placed on the shielding cap and a second part placed on the support; thus, the mean for fixing making it possible to fix the shielding cap to the support for said rotor and stator are distributed on each of said elements;
the first and second parts of said mean for fixing are integrated in said shielding cap and said support, respectively. In other words, each of the parts of said mean for fixing is formed directly in the shielding cap or the support for said rotor and stator. In other words, the first part of the mean for fixing forms an integral piece with the shielding cap and the second part of said mean for fixing forms an integral piece with said support. As a result, this avoids intermediate additional pieces, for example a bolt, in order to fix the shielding cap to the support for said rotor and stator;
the support for said rotor and for said stator and the shielding cap are electrically linked; this characteristic makes it possible to improve the effectiveness of said shielding cap in limiting the propagation of the electromagnetic radiation out from the electric motor;
the mean for fixing comprises at least one stud arranged on the support for said rotor and for said stator and at least one opening, suitable for accommodating said stud, which opening is arranged on the shielding cap;
the support for said rotor and for said stator is produced from a single piece;
the rotor is placed around the stator and the support element for said rotor and for said stator forms a single piece comprising
   a plate used as a heat sink,
   a cylinder supplied with an internal canal used as a support element for the rotor and for the stator.
the second part of the mean for fixing, for example said studs, is arranged on an end of the cylinder of the support for said rotor and for said stator;
the support for said rotor and for said stator is electrically connected to an electrical ground;
the support for said rotor and for said stator and/or the shielding cap are produced from an electrically conductive material;
the shielding cap comprises cut-outs suitable for letting through the hot air generated by the motor and/or the stator;
the shielding cap comprises tabs that are folded to bear on an element of the stator;
the shielding cap is arranged between the rotor and the stator.

The invention also relates to an air blowing device comprising such an electric motor and a method for fixing the shielding cap to the motor support defined above comprising,
a step for inserting the studs through the openings
a step for deforming the studs above the shielding cap.

### BRIEF DESCRIPTION OF THE FIGURES

Other features and advantages of the invention will emerge upon reading the following description, with reference to the appended figures, wherein:

FIG. 1 illustrates a schematic view of an electric motor according to the invention;

FIG. 2 illustrates a shielding cap according to the invention;

FIG. 3 illustrates a partial view of the support for said rotor and for said stator according to the invention;

FIG. 4 illustrates a partial view of the electric motor according to the invention once the shielding cap is fixed on the support for said rotor and for said stator;

FIG. 5 illustrates a schematic view of the electric motor according to another embodiment;

FIG. 6 illustrates the support for said rotor and for said stator according to the embodiment illustrated in FIG. 5.

### DETAILED DESCRIPTION OF THE EMBODIMENTS

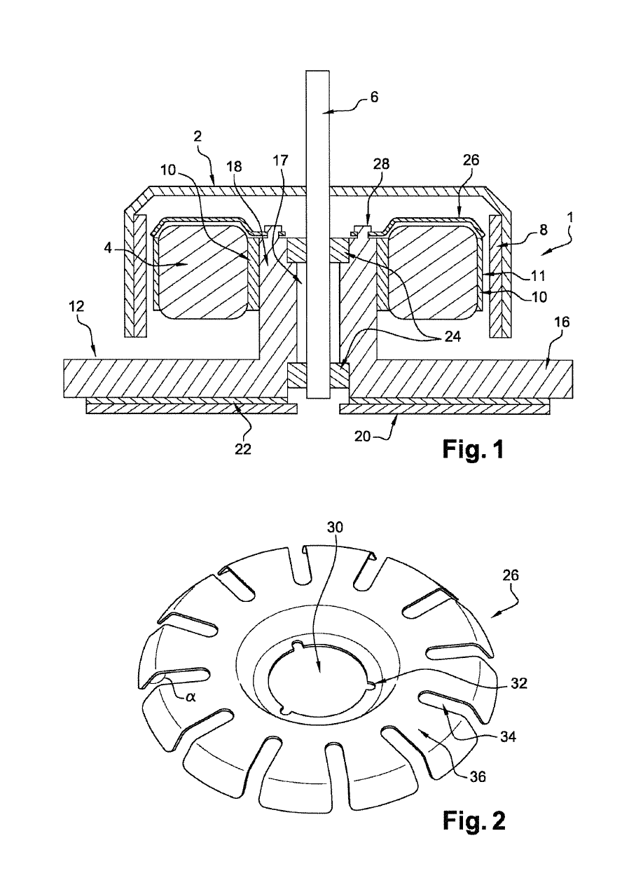

FIG. 1 illustrates a diagram of an electric motor according to the invention according to a sectional view. The electric motor 1 comprises a rotor 2 and a stator 4. The stator 4 has a substantially annular shape with a central wall delimiting the contour of an internal bore through which a transmission shaft 6 passes, which transmission shaft will be described at a later time. The stator 4 further includes one or more magnetic coils generating an electromagnetic field and metal plates 10 which extend substantially parallel to the axis of the transmission shaft 6. Each metal plate 10 is arranged such that a passage zone for the winding of the coil is formed between two adjacent metal plates 10. An electrically insulating plastic layer 11 can also be added to the metal plates 10 in order to insulate the metal plates from the coils or from a magnet 8 which will be described at a later time.

The rotor 2, arranged around the stator 4, carries at least one permanent magnet 8, the interaction of which, with said coils supplied with current, generates a rotating movement of the rotor 2 around the stator 4. The rotor 2 is rigidly connected to the transmission shaft 6 such that, when the rotor 2 revolves, the transmission shaft is also rotated. The transmission shaft 6 is linked to a blade or to a plurality of blades arranged in a wheel, all not illustrated, thus making it possible to generate an air flow when the transmission shaft 6, and therefore the blades, are rotated. The transmission shaft 6 penetrates within the internal bore outlined by the annular shape of the stator 4.

For the transmission shaft 6, as well as the rotor 2 and the stator 4, to remain in a stable position, in other words that these two elements only move in a radial and not an axial manner, these three elements rest on a support 12 for said rotor and for said stator. Said support 12 has the shape of a plate 16 secured to a cylinder 18 placed such as to project from the plate and having an internal canal 17 opening substantially at the center of the plate 16.

The plate 16 extends in a plane substantially perpendicular to the axis of the internal canal 17 of the cylinder 18. The cylinder 18 is suitable to be housed in the internal bore of the stator 4 and to receive the transmission shaft 6 which is rigidly connected to the rotor 2 such that the support 12 for said rotor and for said stator correctly positions the rotor 2 with respect to the stator 4.

It is possible to observe in FIGS. 1, 5 and 6 that the cylinder 18 and the plate 16 form an integral piece. The plate 16 has, for example, a discoidal shape but it can take other shapes, for example rectangular, square, elliptic, etc.

The plate 16 of the support 12 for said rotor and for said stator forms a heat sink carrying a control electronic board 20, in particular for the supply of power to the coils of the stator 4. The control electronic board 20 is placed on the side of the plate that is orientated away from the cylinder 18. An electrically insulating, but thermally conductive, layer 22 can be arranged between the control electronic board 20 and the support 12 for said rotor and for said stator.

Preferably, the support 12 for said rotor and for said stator is made of metal, more particularly aluminum for the lightness and good thermal conduction properties thereof. Thus, the plate 16 used as a heat sink can effectively cool the control electronic board 20 by thermal conduction. Moreover, the fact that the support 12 for said rotor and for said stator is produced from metal makes it possible to block electromagnetic radiation emitted by the electronic member, wherein this radiation can disrupt the operation of other electric components. The support 12 for said rotor and for said stator is electrically connected to an electrical ground, or for example to a substantially zero potential. More specifically, the support 12 for said rotor and for said stator is fixed to a structural element of the vehicle, such as the frame, such that said support 12 is considered to be electrically linked to the earth. Furthermore, the fact that the support 12 for said rotor and for said stator is made from metal makes it possible to electrically link the stator 4 to the ground by means of said support 12.

Two bearings 24 are put into the internal canal 17 of the cylinder 18 in order to serve as a rotation guide for the transmission shaft 6 which is rotated by the rotor 2. These bearings can be ball bearings, as is schematically illustrated, but the invention also covers other forms of bearing such as roller or needle bearings. The two bearings 24 bear on two collars located in the internal canal 17 of the cylinder 18 such as to axially hold the transmission shaft in a fixed position.

The operation of the electric motor, in particular the stator 4, generates electromagnetic waves which can disrupt the operation of other electronic units which are placed in proximity. It is for this reason that a shielding cap 26 is arranged proximate the stator 4 such as to limit the propagation of these waves. The shielding cap 26 corresponds to a stamped sheet of metal.

According to the invention, the shielding cap 26 is advantageously secured as close as possible to the rotor 4 such as to reduce these propagation phenomena. For this purpose, the shielding cap 26, as illustrated in FIG. 1, has a substantially concave shape matching the shape of the stator 4. In order to best retain the electromagnetic waves, the shielding cap also has a substantially annular shape with a diameter equivalent to that of the stator 4.

As can be observed in FIG. 1, the shielding cap 26 is fixed at one end, more particularly the end located at the center of the annular shape, to the support 12 for said rotor and for said stator by a mean for fixing 28. The other end, located in the opposite direction to the center, bears on the stator 4, particularly on the metal plates 10 or on the electrically insulating plastic layer 11.

FIG. 2 illustrates an enlarged view of the shielding cap 26. The shielding cap 26, as seen above, corresponds to a stamped foil of metal having a substantially annular shape. The central part of the shielding cap 26 comprises a hole 30 to allow the transmission shaft, which is not illustrated, to pass through, and at least one, in this case three, opening(s) 32 to allow the mean for fixing 28, which will be described at a later time, to pass through. The openings 32 in this case correspond to round notches which are produced in the shielding cap 26, at the hole 30. Of course, the invention is not limited to the number of openings, nor to the shape thereof, that are produced in the shielding cap 26. It could be possible to envisage, for example, utilizing a shielding cap 26 having four square recesses. As illustrated in FIG. 2, the openings 32 are arranged at the edge, or on the internal periphery, of the shielding cap 26. Of course, the invention also covers, according to an embodiment that is not illustrated, the possibility that these openings 32 are placed at a distance from the internal periphery.

The shielding cap 26 has cut-outs 34, or cuttings, such as to outline tabs 36 isolated from one another by these cut-outs 34. The cut-outs 34 make it possible to evacuate the heat generated by the stator 4. The tabs 36 are folded at the end thereof in order to bear on the metal plates 10 or on the electrically insulating plastic layer 11 such as to limit the vibration phenomena of the shielding cap 26. The tabs 36 are folded at an angle α, in this case obtuse, such that the shielding cap 26 also matches the bell shape of the rotor 2 as illustrated in FIG. 1. In other words, each tab 36 has an end curved in the direction of the stator such as to outline an angle α between the planar central part of the shielding cap 26 and the curved end. The angle α is in a range of angles from 0° to 180° and more particularly in a range of angles between 100° and 160°.

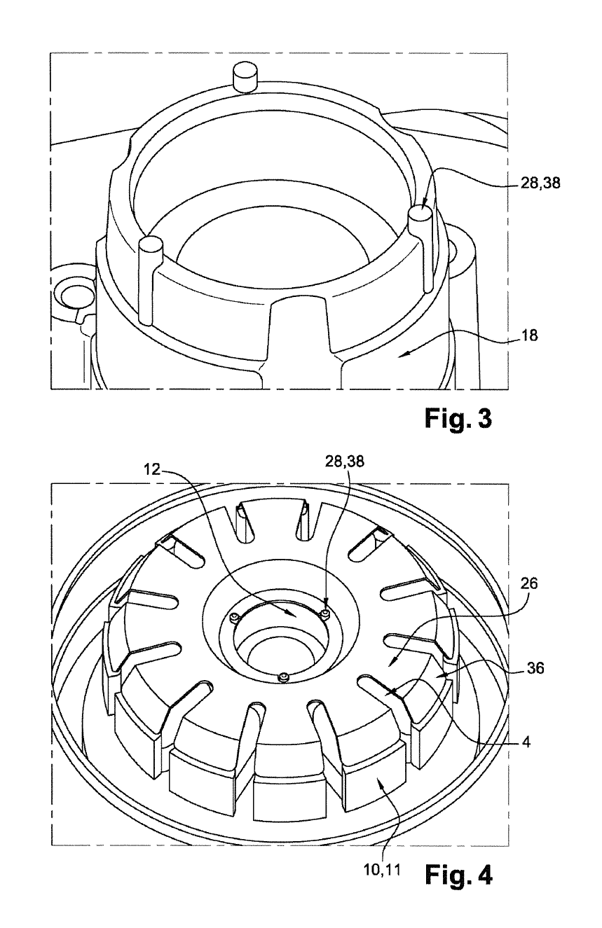

FIG. 3 shows an enlarged view of the cylinder 18 end located away from the plate 16. The cylinder 18 has at least one mean for fixing 28, more specifically a stud 38, in this case three studs, on the end part thereof located away from the plate 16. These studs 38 have a shape, in this case round, complementary to the openings 32 such as to be able to pass therethrough when the shielding cap 26 is inserted onto the support for said rotor and for said stator. After having passed through the openings 32, the studs 38 are then deformed by crimping, heading, pressing or any other method of deformation such that the shielding cap is fixed in a stable manner on the support 12 for said rotor and for said stator. Indeed, the studs 38, being deformed, can no longer pass through the openings 32 such that the shielding cap 26 is axially and radially fixed on the support 12 for said rotor and for said stator.

FIG. 4 illustrates a part of the electric motor according to the invention following the deformation of these studs 38. It can be seen that the shape of the shielding cap 26 matches that of the stator 4 with, at one end, the tabs 36 which bear on the metal plates 10 and/or on the electrically insulating plastic layer 11 and, at the other end, the central part of the shielding cap 26 which is fixed on the support 12 for said rotor and for said stator via the means for fixing 28. The shielding cap also matches the shape of the rotor 2, which rotor is not shown, such as to limit the spatial requirement and to reduce the size of the electric motor as much as possible.

According to another embodiment that is not illustrated, it is possible to provide other positions for the means for fixing, for example on the metal plates 10. The invention is, therefore, not limited to the positioning of the means for fixing. Indeed, it is also possible to provide an embodiment, which is not illustrated, where the studs are arranged on the shielding cap and the openings are placed on the support for said rotor and for said stator. It is possible to provide, in this case, a shoulder projecting from said support and comprising openings such as to accommodate the studs followed by a heading step for example.

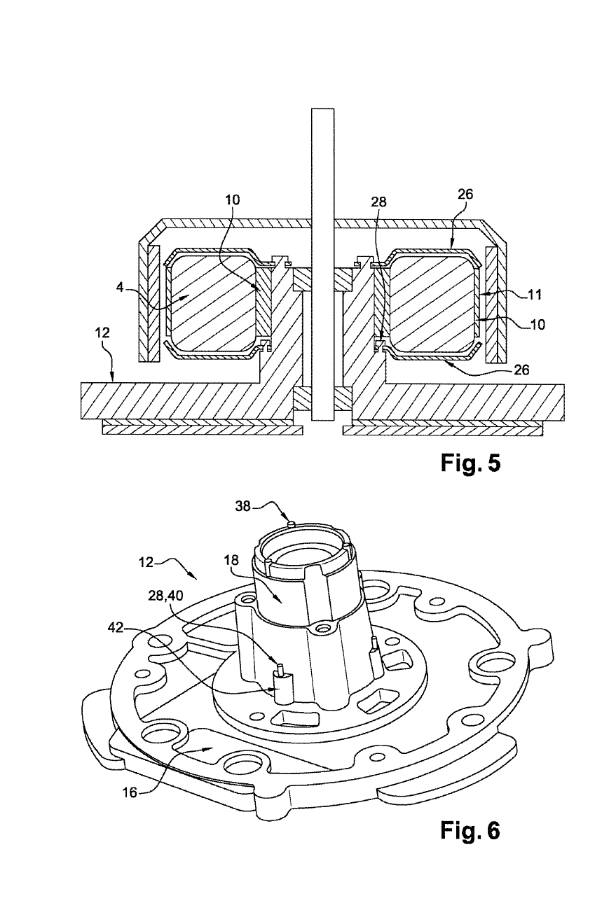

For better containment of the electromagnetic waves, it is possible to add a second shielding cap 26 on the other side of the stator 4, as illustrated in FIG. 5. Since the stator 4 is contained on either side between two shielding caps 26, the electromagnetic waves will propagate less as a result. The second shielding cap 26 thus corresponds to a stamped foil of metal having a same shape similar to the first shielding cap, namely a shape as illustrated in FIG. 2, however with the exception that the internal periphery of the central part must be cut such as to allow through a part of the cylinder 18 of said support 12. Preferably, the second shielding cap 26 matches the shape of the stator 4 in the same manner with, on one side, the central part being fixed to the support 12 for said rotor and for said stator via a mean for fixing 28 and, on the other side, the part, radially furthest from the center, bearing on the metal plates 10 and/or the electrically insulating plastic layer 11.

FIG. 6 illustrates the support 12 for said rotor and for said stator according to the invention in the embodiment with two shielding caps (which are not illustrated). The support 12 for said rotor and for said stator in this case has three studs 38 on the end part of the cylinder 18, i.e. on the side opposite the plate 16, to fix the first shielding cap 26 as described above. Said support 12 further includes additional means for fixing 28 arranged on a central part of the cylinder 18. The additional means for fixing 28 in this case also correspond to studs 40 intended to pass through openings arranged in the central part of the second shielding cap which is not illustrated. The cylinder 18 comprises, for example, three collars 42 arranged on the central part of said cylinder. The collars 42 correspond to parts projecting from the cylinder 18 having a side serving as a bearing area on which the studs 40 are placed.

After having passed through the openings arranged in the second shielding cap, the studs 40 are then deformed by heading, crimping, pressing or any other method of deformation such that the second shielding cap is fixed in a stable manner on the support 12 for said rotor and for said stator. Since the studs 40 are deformed, they can no longer pass through the openings such that the second shielding cap is axially and radially fixed on the support 12 for said rotor and for said stator.

Thus, the shielding caps 26 are arranged firstly between the stator 4 and the rotor 2 and, secondly, between the stator 4 and the support 12 for said rotor and for said stator. This makes it possible to more effectively limit the propagation of the electromagnetic radiation out from the electric motor.

The invention also relates to the method of fixing the shielding cap to the support for said rotor and for said stator. According to the invention, this method comprises, as seen above, a first step of inserting the means for fixing, and particularly the studs, through the openings arranged on the shielding cap, and a second step for deformation, and particularly for heading of the studs above the shielding cap. Of course, this step is repeated twice in the embodiment where the electric motor comprises two shielding caps.

It should, nevertheless, be understood that these examples are given to illustrate the object of the invention. The invention is not limited to these embodiments described above and provided solely by way of example. It includes various modifications, alternative shapes and other variants that a person skilled in the art will be able to envisage within the scope of the present invention and particularly any combination of the various embodiments described above.

1. An electric motor for an air blowing device, comprising:
a rotor;
a stator;
a support for said rotor and for said stator for dissipating heat; and
a shielding cap that is fixed to said support for said rotor and for said stator by a means for fixing.

2. The electric motor as claimed in claim 1, wherein the means for fixing comprises a first part placed on the shielding cap and a second part placed on the support.

3. The motor as claimed in claim 2, wherein the first and second parts of said means for fixing are integrated in said shielding cap and said support, respectively.

4. The motor as claimed in claim 1, wherein the support for said rotor and for said stator and the shielding cap are electrically linked.

5. The motor as claimed in claim 1, wherein the means for fixing comprises at least one stud arranged on the support for said rotor and for said stator and at least one opening for accommodating said stud, is arranged on the shielding cap.

6. The motor as claimed in claim 2, wherein the support element for said rotor and for said stator is made of a single piece comprising;
a plate used as a heat sink, and
a cylinder supplied with an internal canal used as a support element for the rotor and for the stator.

7. The motor as claimed in claim 6, wherein the second part of the means for fixing is arranged on an end of the cylinder of the support for said rotor and for said stator.

8. The motor as claimed in claim 1, wherein the support for said rotor and for said stator is electrically connected to an electrical ground.

9. The motor as claimed in claim 1, wherein the support for said rotor and for said stator and the shielding cap are produced from an electrically conductive material.

10. The motor as claimed in claim 1, wherein the shielding cap comprises cut-outs for letting through hot air generated by the motor and/or the stator.

11. The motor as claimed in claim 1, wherein the shielding cap comprises tabs that are folded to bear on an element of the stator.

12. The motor as claimed in claim 1, wherein the shielding cap is arranged between the rotor and the stator.

13. An air blowing device comprising an electric motor as claimed in claim 1.
